(19) United States
(12) Patent Application Publication
(10) Pub. No.: US 2025/0107477 A1
(43) Pub. Date: Apr. 3, 2025

(54) WORK VEHICLE

(71) Applicant: Kubota Corporation, Osaka-shi (JP)

(72) Inventors: Yosuke HAYASHI, Sakai-shi (JP); Yuki MINAMIDE, Sakai-shi (JP); Tomoyoshi SAKANO, Sakai-shi (JP); Takahiro TAKAKI, Sakai-shi (JP); Kenichi IWAMI, Sakai-shi (JP); Kodai AMITANI, Sakai-shi (JP); Go TAKAKI, Sakai-shi (JP)

(21) Appl. No.: 18/978,015

(22) Filed: Dec. 12, 2024

Related U.S. Application Data
(63) Continuation of application No. PCT/JP2023/023489, filed on Jun. 26, 2023.

(30) Foreign Application Priority Data
Jun. 28, 2022 (JP) 2022-103774

(51) Int. Cl. A01B 69/04

(52) U.S. Cl. CPC A01B 69/008

(57) ABSTRACT

A work vehicle includes a fuel cell module including a fuel cell stack, a motor connected to the fuel cell module, a travel device to be driven by the motor, a controller configured or programmed to control the motor, and a positioning system. The controller is configured or programmed to change a manner of stopping the motor when a travel stop command is issued during motor operation, depending on whether a position of the work vehicle identified by the positioning system is within a field or not. The controller is configured or programmed to make a time from when the travel stop command is issued until the motor stops shorter when the position of the work vehicle is within the field than when the position of the work vehicle is outside the field.

### CROSS REFERENCE TO RELATED APPLICATIONS

This application claims the benefit of priority to Japanese Patent Application No. 2022-103774 filed on Jun. 28, 2022 and is a Continuation application of PCT Application No. PCT/JP2023/023489 filed on Jun. 26, 2023. The entire contents of each application are hereby incorporated herein by reference.

### BACKGROUND OF THE INVENTION

### 1. Field of the Invention

The present disclosure relates to work vehicles.

### 2. Description of the Related Art

In the field of motor vehicles, where the main purpose is to transport “people” or “objects,” electric vehicles (EVs) are becoming increasingly popular. In these vehicles, the driving force (traction) is generated by an electric motor (hereinafter referred to as “motor”) instead of an internal combustion engine.

On the other hand, there is a need to reduce the amount of carbon dioxide (CO₂) emitted by work vehicles, such as tractors used in agricultural fields, to realize a decarbonized society. Unlike typical automobiles, work vehicles such as tractors need to tow implements, which are work machines, to perform agricultural tasks such as plowing. Therefore, to achieve the electrification of work vehicles, there are issues to be solved that differ from those of passenger cars.

Japanese Laid-Open Patent Publication No. 2002-225577 discloses a tractor that includes a fuel cell (FC) power generation system and a motor, while maintaining the t structure of a conventional engine-driven tractor with minimal alteration.

### SUMMARY OF THE INVENTION

Example embodiments of the present invention provide technologies to improve stopping control of a work vehicle equipped with including a fuel cell module.

A work vehicle according to an example embodiment of the present disclosure includes a fuel cell module including a fuel cell stack, a motor connected to the fuel cell module, a travel device to be driven by the motor, a controller configured or programmed to control the motor, and a positioning system. The controller is configured or programmed to change a manner of stopping the motor when a travel stop command is issued during driving of the motor, depending on whether a position of the work vehicle identified by the positioning system is within a field or not, and make a time from when the travel stop command is issued until the motor stops shorter when the position of the work vehicle is within the field than when the position of the work vehicle is outside the field.

Comprehensive or specific example embodiments of the present disclosure may be achieved by apparatuses, systems, methods, integrated circuits, computer programs, or computer-readable non-transitory storage media, or any combination thereof. The computer-readable storage media may include volatile storage media or non-volatile storage media. The apparatuses may include with a plurality of devices. When the apparatuses include two or more devices, the two or more devices may be arranged within a single equipment or may be arranged separately in two or more pieces of equipment.

According to example embodiments of the present disclosure, it becomes possible to improve stopping control of a work vehicle equipped with a fuel cell module.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view schematically showing a basic configuration example of a work vehicle according to an example embodiment of the present disclosure.

FIG. 2 is a diagram showing a basic configuration example of a fuel cell power generation system mounted on the work vehicle.

FIG. 3 is a block diagram schematically showing an example of electrical connections and power transmission between components of a work vehicle according to an example embodiment of the present disclosure.

FIG. 4 is a block diagram schematically showing paths of electrical signals (solid thin lines) and coolant paths (dotted lines) between components of a work vehicle according to an example embodiment of the present disclosure.

FIG. 5 is a perspective view schematically showing a configuration example of a work vehicle according to an example embodiment of the present disclosure.

FIG. 6 is a side view schematically showing a configuration example of a work vehicle according to an example embodiment of the present disclosure.

FIG. 7 is a block diagram schematically showing a configuration example of the positioning system.

FIG. 8 is a flowchart showing an example of processing procedures for the operation of the controller.

### DETAILED DESCRIPTION OF THE EXAMPLE EMBODIMENTS

The following describes example embodiments of the present disclosure. However, excessively detailed explanations may be omitted. For example, detailed explanations of well-known matters and repetitive explanations of substantially identical configurations may be omitted. This is to avoid the following description from becoming unnecessarily redundant and to facilitate understanding by those skilled in the art. The inventors provide the attached drawings and the following description to enable those skilled in the art to fully understand this disclosure, and do not intend to limit the subject matter described in the claims by these drawing and description. In the following description, the same reference numerals are used for components with the same or similar functions.

The following example embodiments are illustrative and not limiting. The technologies disclosed herein are not restricted to the following example embodiments. For instance, the numerical values, shapes, materials, steps, the order of those steps, screen layouts, and other elements shown in the following example embodiments are merely examples. Various modifications can be made as long as no technical contradictions arise. Additionally, different features, elements, characteristics, etc., of the example embodiments may be combined as long as there are no technical contradictions.

In this disclosure, the term “work vehicle” refers to a vehicle used to perform a task at a work site. A “work site” includes any place where work is carried out, such as a field, forest, or construction site. A “field” refers to any place where agricultural work is performed, such as an orchard, farm, paddy field, grain farm, or pasture. A work vehicle may include an agricultural machine such as a tractor, rice planter, combine harvester, riding field management vehicle, or riding mower, as well as a non-agricultural vehicle such as a construction work vehicle or snowplow. The work vehicles described in this disclosure may be equipped with an implement (also called a “work machine” or “work device”) attached to at least one of its front and rear portions, depending on the nature of the work. Travel of a work vehicle while performing a task may be referred to as “tasked travel.”

An “agricultural machine” refers to a machine for agricultural application. Examples of agricultural machines include tractors, harvesters, rice planters, riding field management vehicles, vegetable transplanters, mowers, seeders, spreaders, and agricultural mobile robots. Not only may a work vehicle such as a tractor function as an “agricultural machine” on its own, but also the entire combination of a work vehicle and an implement attached to or towed by the work vehicle may function as an “agricultural machine.” An agricultural machine performs agricultural work on the ground in a field, such as tilling, seeding, pest control, fertilizing, planting crops, or harvesting.

“Self-driving” refers to controlling the movement of agricultural machine through the function of a controller without manual operation by an operator. An agricultural machine performing self-driving may be referred to as an “self-driving agricultural machine” or a “robotic agricultural machine”. During self-driving, not only the movement of the agricultural machinery but also agricultural work operations (e.g., implement operations) may be automatically controlled. When the agricultural machine is a vehicle-type machine, traveling of the agricultural machine by self-driving is referred to as “self-traveling”. The controller may be configured or programmed to control at least one of steering, travel speed adjustment, and start and stop of movement necessary for the movement of the agricultural machine. When controlling a work vehicle with an implement attached, the controller may also be configured or programmed to control operations such as raising and lowering the implement, and starting and stopping the operation of the implement. Movement by self-driving may include not only movement of the agricultural machine along a predetermined path toward a destination, but also movement following a tracking target. Agricultural machine performing self-driving may partially move based on user instructions. Additionally, the agricultural machine performing self-driving may operate in a manual operation mode in which it moves by manual operation of the operator, in addition to the self-driving mode. Steering the agricultural machine through the function of the controller without manual operation is referred to as “automatic steering”. A portion or entirety of the controller may be external to the agricultural machine. Communication of control signals, commands, or data may occur between the controller external to the agricultural machine and the agricultural machine. An agricultural machine performing self-driving may move autonomously while sensing the surrounding environment without human involvement in controlling the movement of the agricultural machine. The agricultural machine capable of autonomous movement can travel unmanned within the field or outside the field (e.g., on roads). During autonomous movement, obstacle detection and obstacle avoidance maneuvers may be performed.

An “environment map” is data that expresses the position or area of objects existing in the environment where the agricultural machine moves, using a predetermined coordinate system. The environment map may be simply referred to as a “map” or “map data”. The coordinate system defining the environment map may be, for example, a world coordinate system such as a geographic coordinate system fixed to the Earth. The environment map may include information other than position (e.g., attribute information and other information) about objects existing in the environment. The environment map includes various types of maps such as point cloud maps or grid maps. Local maps or partial maps generated or processed in the process of constructing the environment map are also referred to as “maps” or “map data”.

An example of the basic configuration and operation of a work vehicle according to an example embodiment of the present disclosure will be described. The work vehicle described below includes a motor and a fuel cell power generation system (hereinafter referred to as “FC power generation system”) that performs the power generation necessary to drive the motor.

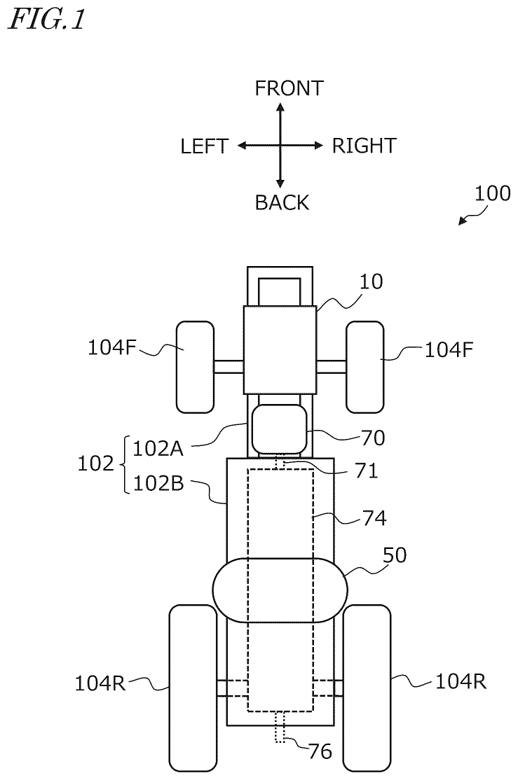

FIG. 1 is a schematic plan view showing an example of the basic configuration of a work vehicle 100 in this disclosure. In this disclosure, the direction in which the work vehicle 100 travels straight forward is called the “forward direction,” and the direction in which it travels straight backward is called the “backward direction.” In a plane parallel to the ground, the direction extending perpendicularly to the right of the “forward direction” is called the “right direction,” and the direction extending perpendicularly to the left is called the “left direction.” In FIG. 1, the “forward direction,” “backward direction,” “right direction,” and “left direction” are indicated by arrows labeled “front,” “back,” “right,” and “left” respectively. Both the forward and backward directions may be collectively referred to as the “front-back direction.”

The work vehicle 100 illustrated in this example is, for instance, a tractor, which defines and functions as an example of agricultural machinery. The technologies disclosed herein are not limited to work vehicles such as tractors and may be applied to other types of work vehicles. The work vehicle 100 is configured to attach or tow an implement and travel within a field while performing agricultural tasks appropriate to the type of implement. Additionally, the work vehicle 100 is configured to travel both within and outside the field (including on roads) with the implement raised or without an implement attached.

The work vehicle 100, like a conventional tractor, includes a vehicle frame 102 that rotatably supports left and right front wheels 104F and left and right rear wheels 104R. The vehicle frame 102 includes a front frame 102A where the front wheels 104F are mounted, and a transmission case 102B where the rear wheels 104R are mounted. The front frame 102A is fixed to the front portion of the transmission case 102B. The front wheels 104F and rear wheels 104R may be collectively referred to as wheels 104. Strictly speaking, the wheels 104 refer to wheel rims with tires attached. In this disclosure, the term “wheel” generally refers to the entire assembly of the “wheel rim and tire.” Either or both of the front wheels 104F and rear wheels 104R may be reprovided with a plurality of wheels (crawler) equipped with endless tracks instead of wheels with tires. In this specification, the left and right front wheels 104F and left and right rear wheels 104R, the axles that rotate these four wheels, and the braking devices (brakes) that brake each axle may be collectively referred to as the “travel device.”

In the example shown in FIG. 1, the work vehicle 100 includes a fuel cell module (FC module) 10 and a motor 70, which are directly or indirectly supported by the front frame 102A. The FC module 10 includes a fuel cell stack (FC stack) and functions as an onboard power generator that generates electricity from fuel, as will be described later. Hereinafter, the terms “FC module” or “FC stack” may simply be referred to as “fuel cell.”

The motor 70 is electrically connected to the FC module 10. The motor 70 converts the electric power generated by the FC module 10 into mechanical motion (power) to produce the driving force (traction) necessary for the work vehicle 100 to travel. An example of the motor 70 is an AC synchronous motor. Since the FC stack of the FC module 10 generates direct current, when the motor 70 is an AC synchronous motor, a group of electrical circuits, including an inverter device, is installed between the FC stack and the motor 70 to convert the direct current to alternating current. A portion of such electrical circuit group may be inside the FC module 10, while another portion of the electrical circuit group may be attached to the motor 70 as a motor drive circuit.

The motor 70 includes an output shaft 71 that rotates. The torque of the output shaft 71 is transmitted to the rear wheels 104R through mechanical components such as a transmission (gearbox) and a rear wheel differential gear device installed inside the transmission case 102B. In other words, the power generated by the motor 70, which serves as the power source, is transmitted to the rear wheels 104R through a power transmission system (drivetrain) 74 including the transmission installed in the transmission case 102B. For this reason, the “transmission case” may also be referred to as a “mission case.” In four-wheel drive mode, a portion of the power of the motor 70 is also transmitted to the front wheels 104F. The power of the motor 70 may be used not only to drive the work vehicle 100 but also to operate implements. Specifically, a power take-off (PTO) shaft 76 is provided at the rear end of the transmission case 102B. The PTO shaft 76 is driven by the motor 70 and is configured to be connected to implements. The torque from the output shaft 71 of the motor 70 is transmitted to the PTO shaft 76. Implements attached to or towed by the work vehicle 100 are configured to receive power from the PTO shaft 76 to perform various work-related operations. The motor 70 and the power transmission system 74 may collectively be referred to as an electric powertrain.

Thus, the work vehicle 100 disclosed herein does not include an internal combustion engine such as a diesel engine, but includes the FC module 10 and the motor 70. Additionally, the output shaft 71 of the motor 70 is mechanically coupled to the power transmission system 74, including the transmission in the transmission case 102B. The motor 70 efficiently generates torque over a relatively wide range of rotational speeds compared to an internal combustion engine. However, by utilizing the power transmission system 74, including the transmission, it becomes easier to adjust the torque and rotational speed from the motor 70 over an even wider range by performing multi-stage or continuously variable speed change operations. This configuration allows for efficient execution of not only the travel of the work vehicle 100 but also various operations using implements.

Depending on the application or size of the work vehicle 100, some functions of the power transmission system 74 may be omitted. For example, a portion or an entirety of the transmission responsible for speed change functions may be omitted. The number and mounting position of motors 70 are also not limited to the example shown in FIG. 1.

The work vehicle 100 includes at least one fuel tank 50 that stores fuel to be supplied to the FC module 10. For simplicity, FIG. 1 shows one fuel tank 50. In some example embodiments, a plurality of fuel tanks 50 may be housed in a tank case to define a fuel tank module. The fuel tank 50 is supported by structural elements fixed to the vehicle frame 102A described later. The FC module 10 and the fuel tank 50 are connected by piping and open/close valves, and similar components, defining an FC power generation system mounted on a vehicle. The configuration and operation of the FC power generation system will be described later.

The work vehicle 100 in the example embodiments described later includes a seat for a driver, hereinafter referred to as “a driver seat,” supported by the vehicle frame 102. The driver seat may be enclosed by a cabin supported by the vehicle frame 102. In the example embodiments described later, the FC module 10 is positioned in front of the driver seat, and the fuel tank 50 is positioned above the driver seat. Such FC module 10 and fuel tank 50 are housed in at least one “enclosure.” The “enclosure” functions as a housing, for example, and plays a role in protecting the FC module 10 and fuel tank 50 from sunlight exposure and wind and rain. Additionally, such an enclosure is designed to control the spread of fuel gas into the atmosphere and to facilitate the detection of fuel gas when fuel gas leaks from the FC module 10 or fuel tank 50.

The FC module 10 may be housed in a front housing called a “bonnet,” for example. The front housing is a portion of the “enclosure.” The front housing is supported by the front portion of the vehicle frame 102 (front frame 102A). The fuel tank 50 is housed in a tank case, as mentioned earlier. The tank case is directly or indirectly supported by the vehicle frame 102.

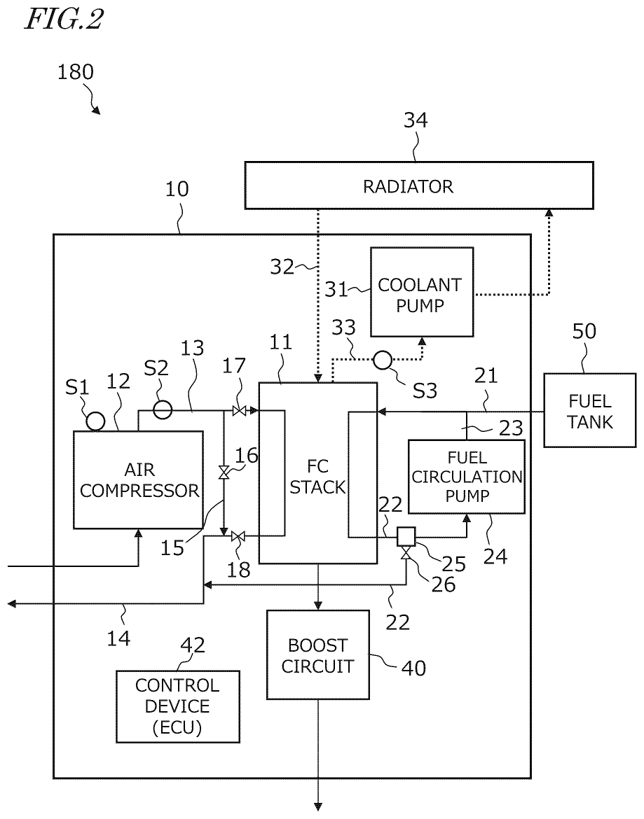

Next, referring to FIG. 2, a basic configuration example of the FC power generation system 180 mounted on the work vehicle 100 will be explained.

The FC power generation system 180 shown in FIG. 2 functions as an onboard power generation system in the work vehicle 100 of FIG. 1. The electric power generated by the FC power generation system 180 is used not only for the travel of the work vehicle 100 but also for the operation of implements towed or attached to the work vehicle 100.

The FC power generation system 180 in the illustrated example includes the FC module 10 and at least one fuel tank 50 that stores fuel to be supplied to the FC module 10. The FC power generation system 180 also includes a radiator 34 to cool the FC module 10.

The FC module 10 includes main components such as a fuel cell stack (FC stack) 11, an air compressor 12, a fuel circulation pump 24, a coolant pump 31, a boost circuit 40, and a controller 42. These components are housed within the casing of the FC module 10 and are connected to each other through electrical or fluid communication.

The FC stack 11 generates electric power through an electrochemical reaction between the fuel, referred to as “anode gas” and the oxidizing gas, referred to as “cathode gas.” In this example, the FC stack 11 includes polymer electrolyte fuel cells. The FC stack 11 has a stack structure in which a plurality of single cells (fuel cell elements) are stacked. A single cell includes, for example, an electrolyte membrane including an ion exchange membrane, an anode electrode on one side of the electrolyte membrane, a cathode electrode on the other side of the electrolyte membrane, and a pair of separators sandwiching the anode electrode and cathode electrode on both sides. The voltage generated in a single cell is, for example, less than 1 volt. Therefore, in the FC stack 11, for instance, more than 300 single cells are connected in series to generate a voltage of several hundred volts.

Anode gas is supplied to the anode electrode of the FC stack 11. The anode gas is called “fuel gas” or simply “fuel.” In the example embodiments of this disclosure, the anode gas (fuel) is hydrogen gas. Cathode gas is supplied to the cathode electrode. The cathode gas is an oxidizing gas such as air. The anode electrode is called the fuel electrode, and the cathode electrode is called the air electrode.

At the anode electrode, the electrochemical reaction shown in the following equation (1) occurs.

2H₂→4H⁺+4e⁻ equation (1)

At the cathode electrode, the electrochemical reaction shown in the following equation (2) occurs.

4H⁺+4e⁻+O₂→2H₂O equation (2)

Overall, the reaction shown in the following equation (3) occurs.

2H₂+O₂→2H₂ equation (3)

The anode gas after being used in the above reaction is called “anode off-gas”, and the cathode gas after being used in the reaction is called “cathode off-gas.”

The air compressor 12 supplies air taken from the outside as cathode gas to the cathode electrode of the FC stack 11. The cathode gas supply system including the air compressor 12 includes a cathode gas supply pipe 13, a cathode off-gas pipe 14, and a bypass pipe 15. The cathode gas supply pipe 13 flows cathode gas (air) supplied from the air compressor 12 to the cathode electrode of the FC stack 11. The cathode off-gas pipe 14 flows cathode off-gas discharged from the FC stack 11 to the outside air. The bypass pipe 15 branches from the cathode gas supply pipe 13 downstream of the air compressor 12, bypasses the FC stack 11, and connects to the cathode off-gas pipe 14. A control valve 16 is provided on the bypass pipe 15 to adjust the flow rate of cathode gas flowing through the bypass pipe 15. A shut-off valve 17 is provided on the cathode gas supply pipe 13 to selectively block the inflow of cathode gas to the FC stack 11. A pressure regulating valve 18 is provided on the cathode off-gas pipe 14 to adjust the back pressure of the cathode gas.

The cathode gas supply system of the FC module 10 includes a rotation speed detection sensor S1 that detects the rotation speed of the air compressor 12 and a gas flow rate detection sensor S2 that detects the flow rate of cathode gas flowing through the cathode gas supply pipe 13. The control valve 16, shut-off valve 17, and pressure regulating valve 18 are, for example, electromagnetic valves.

The fuel circulation pump 24 supplies fuel gas (anode gas) sent from the fuel tank 50 to the anode electrode of the FC stack 11. The anode gas supply system including the fuel circulation pump 24 includes an anode gas supply pipe 21, an anode off-gas pipe 22, and a circulation path 23. The anode gas supply pipe 21 flows anode gas supplied from the fuel tank 50 to the anode electrode of the FC stack 11. In the example embodiments of this disclosure, the fuel tank 50 is a hydrogen tank that stores high-pressure hydrogen gas.

The anode off-gas pipe 22 flows anode off-gas discharged from the FC stack 11. The anode off-gas is led through the anode off-gas pipe 22 to a gas-liquid separator 25 in which moisture is removed. The anode off-gas with moisture removed returns to the anode gas supply pipe 21 through the circulation path 23 by the fuel circulation pump 24. The anode off-gas circulating through the circulation path 23 can be discharged through the anode off-gas pipe 22 by opening an exhaust valve 26. Moisture accumulated in the gas-liquid separator 25 can be discharged through the anode off-gas pipe 22 by opening the exhaust valve 26. The exhaust valve 26 is, for example, an electromagnetic valve. In the example shown in the figure, the anode off-gas pipe 22 is connected to the cathode off-gas pipe 14. By adopting this configuration, it is possible to improve the utilization efficiency of the anode gas by circulating the anode off-gas containing unreacted anode gas that did not contribute to the electrochemical reaction and supplying it again to the FC stack 11.

To enhance the performance of the FC stack 11, temperature control is important. When generating electricity through the reaction of producing water from hydrogen gas and oxygen gas, heat is also generated, necessitating cooling. FIG. 2 shows a coolant circulation system including a coolant pump 31 for the FC stack 11, but as described later, cooling circulation systems for other electrical equipment may also be provided. Note that the air compressor 12, fuel circulation pump 24, and coolant pump 31 included in the FC module 10 are driven by individual built-in motors. These motors are also electrical equipment.

The coolant circulation system including the coolant pump 31 shown in FIG. 2 includes a coolant supply pipe 32, a coolant discharge pipe 33, a radiator device 34, and a temperature sensor S3. This coolant circulation system is configured to adjust the temperature of the FC stack 11 within a predetermined range by circulating coolant through the FC stack 11. The coolant is supplied to the FC stack 11 through the coolant supply pipe 32. The supplied coolant flows through a coolant path between single cells and is discharged into the coolant discharge pipe 33. The coolant discharged into the coolant discharge pipe 33 flows to the radiator device 34. The radiator device 34 performs heat exchange between the incoming coolant and the outside air to release heat from the coolant, and then resupplies the cooled coolant to the coolant supply pipe 32.

The coolant pump 31 is provided on either the coolant supply pipe 32 or the coolant discharge pipe 33 to pump coolant to the FC stack 11. A coolant bypass flow path may be provided between the coolant discharge pipe 33 and the coolant supply pipe 32. In that case, a flow dividing valve is provided at the branching point at which the coolant bypass flow path branches from the coolant discharge pipe 33. The flow dividing valve is configured to adjust the flow rate of coolant flowing through the bypass flow path. The temperature sensor S3 detects the temperature of the coolant flowing through the coolant discharge pipe 33.

The coolant used to cool the FC stack 11 is circulated through the flow path by an electric coolant pump 31. A coolant control valve may be provided downstream of the FC stack 11. The coolant control valve adjusts the ratio of coolant flowing to the radiator device 34 and coolant bypassing the radiator device 34, enabling more accurate control of the coolant temperature. Furthermore, by controlling the liquid delivery amount by the coolant pump, it is also possible to control the coolant temperature difference between the inlet and outlet of the FC stack 11 to be within a desired range. The temperature of the coolant in the FC stack 11 may be controlled to be around 70° C., for example, which is a temperature where the power generation efficiency of the FC stack 11 is high.

The coolant flowing through the FC stack 11 preferably has higher insulation properties compared to the coolant used to cool ordinary electrical equipment. Since voltages exceeding 300 volts can occur in the FC stack 11, increasing the electrical resistance of the coolant allows for the reduction or prevention of current leakage through the coolant or devices such as the radiator device 34. The electrical resistance of the coolant may decrease as the coolant is used. This is because ions dissolve into the coolant flowing through the FC stack 11. To remove such ions from the coolant and increase insulation property, it is desirable to place an ion exchanger in the coolant flow path.

The boost circuit 40 is configured to increase the voltage output by the FC stack 11 through power generation to a desired level. The subsequent stage of the boost circuit 40 is connected to the high-voltage electrical circuit including an inverter device for motor drive. The subsequent stage of the boost circuit 40 may also be connected in parallel to the low-voltage electrical circuit via a step-down circuit.

The controller 42 may include an electronic control unit (ECU) configured or programmed to control power generation by the FC module 10. The controller 42 is configured or programmed to detect or estimate the operating state of the FC power generation system 180 based on signals output from various sensors. The controller 42 is configured or programmed to control power generation by the FC stack 11 by regulating the operation of the air compressor 12, fuel circulation pump 24, coolant pump 31, and various valves, based on the operating state of the FC power generation system 180 and instructions output from a primary computer or other ECUs. The controller 42 includes, for example, a processor, a storage, and an input/output interface.

In the following description, for simplicity, “anode gas” may be referred to as “fuel gas” or “fuel,” and “anode gas supply pipe” may be referred to as “piping.”

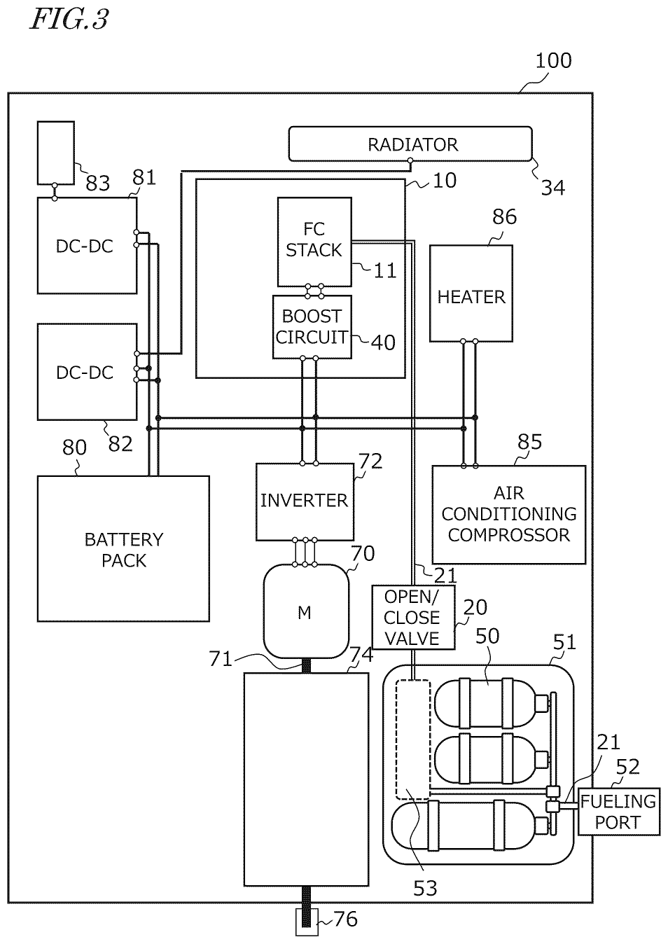

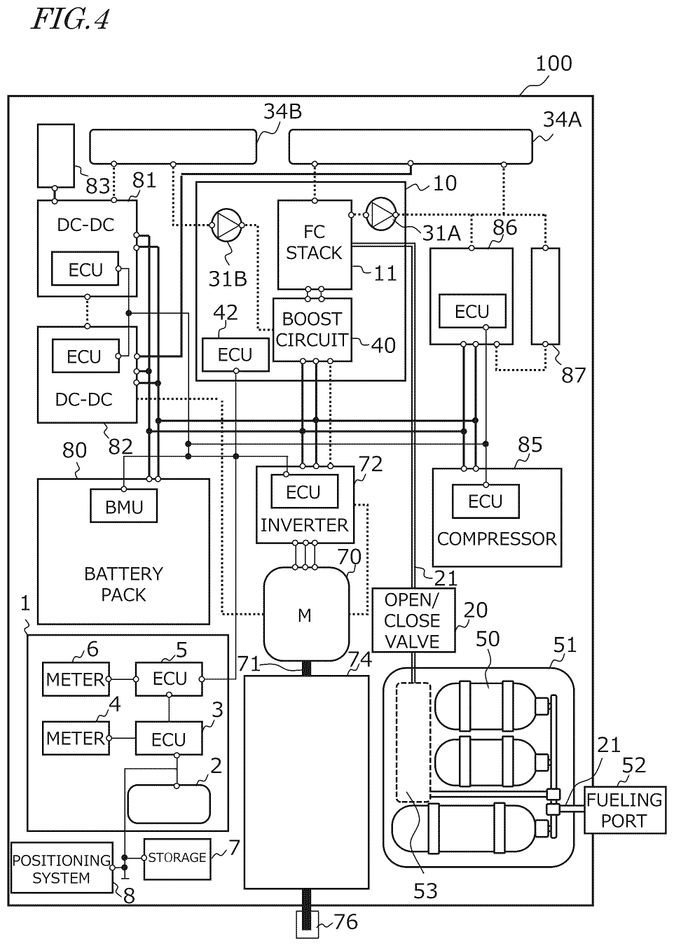

Next, referring to FIG. 3 and FIG. 4, a configuration example of the system of the work vehicle 100 according to this disclosure will be described. FIG. 3 is a block diagram schematically showing an example of electrical connections and power transmission between components of the work vehicle 100 according to this disclosure. FIG. 4 is a block diagram showing a more detailed configuration than the example in FIG. 3. FIG. 4 schematically shows the paths of electrical signals (thin solid lines) and coolant (dotted lines) between components in the work vehicle 100.

First, referring to FIG. 3, an example of the electrical connections and power transmission between components will be described. Electrical connections include both high-voltage and low-voltage systems. High-voltage electrical connections provide, for example, the power supply voltage for inverter devices. Low-voltage electrical connections provide, for example, the power supply voltage for electronic components that operate at relatively low voltages.

In the example shown in FIG. 3, the work vehicle 100 includes an FC module 10, an inverter device 72, a motor 70, a power transmission system 74, and a PTO shaft 76. The DC voltage of the power generated in the FC stack 11 of the FC module 10 is boosted by the boost circuit 40 and then supplied to the inverter device 72. The inverter device 72 converts the DC voltage into, for example, a three-phase AC voltage and supplies it to the motor 70. The inverter device 72 includes a bridge circuit including a plurality of power transistors. The motor 70 includes a rotating rotor and a stator with a plurality of coils electrically connected to the inverter device 72. The rotor is coupled to the output shaft 71, for example, via a reduction gear (speed reducer) or directly. The motor 70 rotates the output shaft 71 with torque and rotational speed controlled according to the waveform of the three-phase AC voltage from the inverter device 72.

The work vehicle 100 further includes a controller (ECU) 72A that controls the motor 70. The controller 72A is connected to the inverter device 72 and is configured or programmed to control the switching operation (turn-on or turn-off) of each of a plurality of power transistors included in the bridge circuit of the inverter device 72. The controller 72A may be connected to the inverter device 72 via a pre-driver (which may be referred to as a “gate driver”). The controller 72A may operate under the control of a primary computer.

The torque of the output shaft 71 of the motor 70 is transmitted to the power transmission system 74. The power transmission system 74 operates with the motor 70 as the power source to drive the wheels 104R and 104F, as shown in FIG. 1, and/or the PTO shaft 76. This power transmission system 74 may have the same or a similar structure as the power transmission system in conventional tractors including internal combustion engines such as diesel engines. By adopting a power transmission system used in agricultural tractors, for example, it is possible to reduce the design and manufacturing costs for producing an agricultural work vehicle 100 including an FC power generation system. The power transmission system 74 includes a travel power transmission mechanism that transmits power from the motor 70 to the left and right rear wheels 104R through a clutch, transmission, and rear wheel differential device, as well as a PTO power transmission mechanism that transmits power from the motor 70 to the PTO shaft 76. The transmission case 102B in FIG. 1 may be divided into a front case (mission case) housing the clutch and transmission and related components, and a rear case (differential gear case) housing the rear wheel differential device and related components. The rear case may also be referred to as a rear axle case.

The work vehicle 100 includes a secondary battery (battery pack) 80 that temporarily stores electrical energy generated by the FC module 10. An example of the battery pack 80 includes a pack of lithium-ion batteries. The battery pack 80 is electrically connected to the FC module 10 and electrically connected to the motor 70 via the inverter device 72. The battery pack 80 is configured to supply power to the inverter device 72 at the necessary timing in cooperation with the FC module 10 or independently. Various battery packs used in electric passenger vehicles may be adopted as the battery pack 80. Hereinafter, the battery pack 80 may be simply referred to as “battery 80.”

The work vehicle 100 includes various electrical equipment (onboard electronic components) that operates on electricity, in addition to the motor 70 and the inverter device 72. Examples of electrical equipment include electromagnetic valves such as open/close valves 20, air cooling fans of the radiator device 34, electric pumps of air conditioning compressors 85, and temperature controllers for heating or cooling the FC stack 11. The temperature controllers include electric heaters 86. First and second DC-DC converters 81 and 82 to obtain appropriate power supply voltages for the operation of electrical equipment, and storage batteries 83 may also be included in the electrical equipment. Furthermore, various electronic components not shown (such as lamps, electric motors for hydraulic systems) may be included in the electrical equipment. The electrical equipment may be electronic components similar to electrical equipment installed in conventional agricultural tractors.

In the example of FIG. 3, the first DC-DC converter 81 is a circuit that steps down the voltage output from the boost circuit 40 of the FC module 10 to a first voltage, for example, 12 volts. The storage battery 83 is, for example, a lead-acid battery and stores electrical energy at the voltage output from the first DC-DC converter 81. The storage battery 83 may be used as a power source for various electrical equipment such as lamps.

The work vehicle 100 shown in FIG. 3 includes not only the first DC-DC converter 81 but also a second DC-DC converter 82 as a voltage conversion circuit that steps down the high voltage output by the FC module 10. The second DC-DC converter 82 is a circuit that steps down the voltage output from the boost circuit 40 of the FC module 10 (for example, several hundred volts) to a second voltage higher than the first voltage, for example, 24 volts. The air cooling fan of the radiator device 34, for example, is configured to operate on the voltage output from the second DC-DC converter 82. Note that although the radiator device 34 is described as a single component in FIG. 3, one work vehicle 100 may include a plurality of radiator devices 34. Additionally, the electric pump of the air conditioning compressor 85 and the electric heater 86 are configured to operate on the voltage output from the second DC-DC converter 82.

The work vehicle 100 shown in FIG. 3 includes a temperature controller that cools or heats the FC stack 11 included in the FC power generation system. The operation of the temperature controller or alike requires relatively large power. The relatively high 24-volt voltage output by the second DC-DC converter 82 is applied to the temperature controller. In this example embodiment, the temperature controller includes the radiator device 34 that releases heat from the coolant cooling the FC stack 11, and the relatively high 24-volt voltage (second voltage) output by the second DC-DC converter 82 is applied to the radiator device 34. The temperature controller includes a heater 86 that heats the FC stack 11. The relatively high voltage output by the second DC-DC converter 82 may also be applied to the heater. The relatively high voltage output by the second DC-DC converter 82 may also be applied to air conditioning devices such as the air conditioning compressor 85.

The work vehicle 100 may include a third voltage conversion circuit that converts the high voltage output by the FC module 10 to a third voltage higher than the second voltage. The third voltage is, for example, 48 volts. If the work vehicle 100 includes another motor in addition to the motor 70, for example, the third voltage may be used as the power source for such other motors.

In an agricultural work vehicle including a fuel cell power generation system, in addition to the electrical equipment necessary for agricultural task, the agricultural work vehicle also includes electrical equipment necessary for the operation of fuel cell power generation, so the appropriate voltage magnitude may differ for each electrical equipment. According to the example embodiments of this disclosure, it is possible to supply voltages of appropriate magnitudes.

In the example shown in FIG. 3, a plurality of fuel tanks 50 are housed in a single tank case 51. The fuel tank 50 is connected to a supplying port (fueling port) 52 through which fuel is supplied from the outside. This connection is made via piping 21 for flowing fuel gas. The fuel tank 50 is also connected to the FC module 10 via piping 21, which is equipped with an open/close valve 20. When hydrogen is used as the fuel gas, the piping 21 may be formed from materials with high resistance to hydrogen embrittlement, such as austenitic stainless steel like SUS316L.

A valve space 53 is provided in the tank case 51, and various valves including a pressure reducing valve are provided in the valve space 53. Through various valves provided in the valve space 53, the piping 21 connects the fuel tank 50 and the FC module 10. Fuel gas with reduced pressure by the pressure reducing valve flows through the piping 21 connecting the tank case 51 and the FC module 10. When the fuel gas is hydrogen gas, high-pressure hydrogen gas of, for example, 35 megapascals or more may be filled in the fuel tank 50, but the hydrogen gas after passing through the pressure reducing valve may be reduced to about 2 atmospheres or less.

Next, refer to FIG. 4. In addition to what is shown in FIG. 3, FIG. 4 shows a plurality of ECUs that communicate within the work vehicle 100 and a user interface 1. Communication can be executed via CAN bus wiring and other similar communication pathways, which function as paths for electrical signals (thin solid lines). FIG. 4 also shows a cooling system to perform thermal management of Specifically, the path of coolant (dotted line) is schematically shown.

As mentioned above, the first and second DC-DC converters 81 and 82 are configured to output voltages of different magnitudes. ECUs are also provided for these first and second DC-DC converters 81 and 82 to control each voltage conversion circuit. The relatively low first voltage which the first DC-DC converter 81 outputs is applied to these ECUs, like other ECUs.

In the example of FIG. 4, the work vehicle 100 includes a cooling system in which coolant circulates via coolant pumps 31A and 31B. These coolant pumps 31A and 31B are provided inside the FC module 10. The cooling system in this example includes a first radiator device 34A to cool the FC stack 11 and a second radiator device 34B to cool other electrical equipment. The cooling system includes a flow path (first flow path) where coolant flows between the FC stack 11 and the first radiator device 34A. Furthermore, this cooling system has a flow path (second flow path) where coolant flows between electrical equipment including the motor 70 and the second radiator device 34B. In the example of FIG. 4, for instance, a heater core 87 used to heat the cabin is provided, and the coolant flowing through the first radiator device 34A flows through the heater core 87.

The user interface 1 includes an operation device 2 such as an accelerator pedal (or accelerator lever) and a main ECU 3 connected to the operation device 2. The main ECU 3 is communicably connected via a bus to a main meter 4, a storage 7, a positioning system 8, and similar components. The storage 7 and positioning system 8 will be described later. The main meter 4 may display various parameters that identify the travel state or operating state of the work vehicle 100. The user interface 1 further includes an FC system ECU 5 to control the FC power generation system. The FC system ECU 5 is connected to an FC meter 6. The FC meter 6 may display various parameters that identify the operating state of the FC power generation system.

The storage 7 includes one or more storage media such as flash memory or magnetic disks. The storage 7 stores various data generated by the main ECU 3 and FC system ECU 5. The storage 7 also stores computer programs that cause the main ECU 3 and FC system ECU 5 to perform desired operations. The computer programs may be provided to the work vehicle 100 via storage media (e.g., semiconductor memory or optical discs) or telecommunication lines (e.g., the Internet). The computer programs may be sold as commercial software.

The work vehicle 100 may further include a positioning system 8. The positioning system 8 includes, for example, a GNSS (Global Navigation Satellite System) receiver used for positioning, and an external sensor that senses the external state of the work vehicle 100. An example of the block configuration of the positioning system 8 will be described later.

The cells of the battery pack 80 are controlled by a Battery Management Unit (BMU). The BMU includes circuits and a CPU (Central Processing Unit) that perform voltage monitoring for each cell of the battery, monitoring of overcharging and over-discharging, and cell balance control. These circuits and CPU may be mounted on a battery controller board.

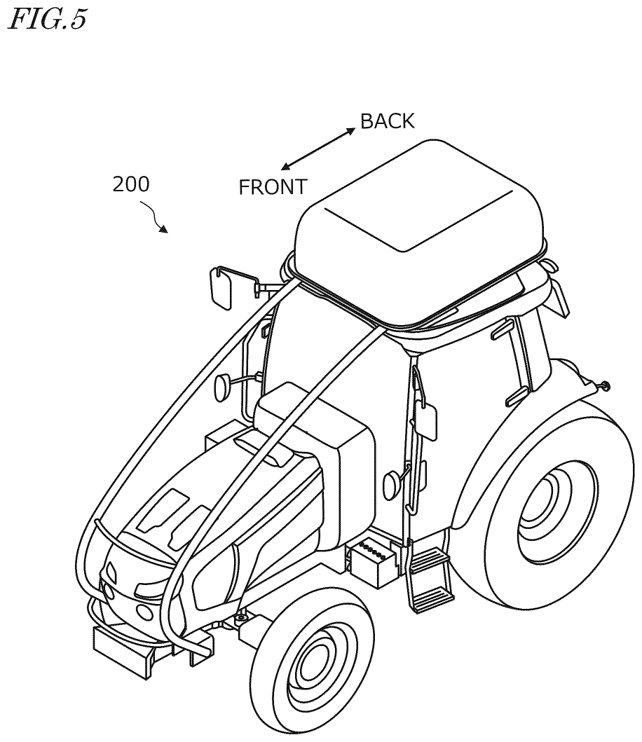

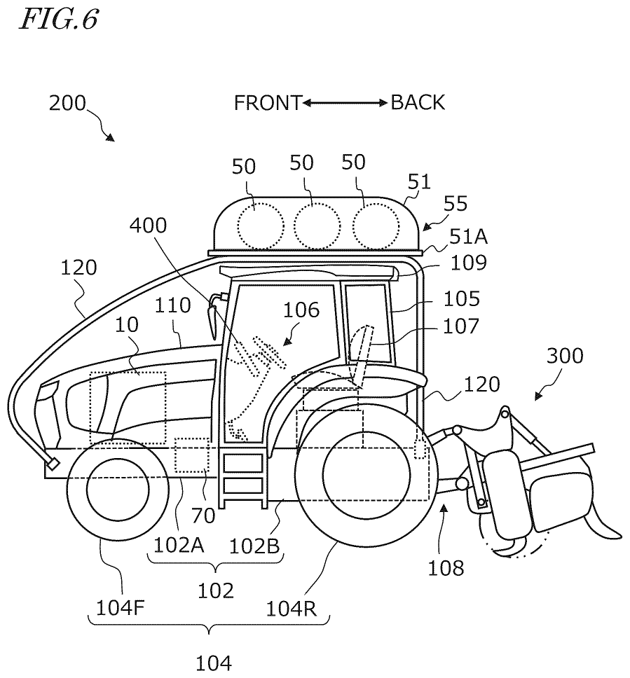

Next, referring to FIG. 5 and FIG. 6, the basic configuration of the work vehicle according to the example embodiments of this disclosure will be explained. FIG. 5 is a perspective view schematically showing a configuration example of the work vehicle 200 in this example embodiment. FIG. 6 is a side view schematically showing a configuration example of the work vehicle 200 in this example embodiment.

The work vehicle 200 of this example embodiment includes an FC module 10, a fuel tank 50, a motor 70, a driver seat 107, a vehicle frame 102, a controller, and a traveling device. The work vehicle 200 includes a configuration similar to that of the work vehicle 100 described with reference to FIG. 1.

In the following description, a plurality of ECUs involved in system control of the work vehicle 200, including the main ECU 3, FC system ECU 5, and ECU 72A, are collectively referred to as the “controller”. The ECU includes a storage (ROM) and may further include, for example, an FPGA (Field Programmable Gate Array) and/or a GPU (Graphics Processing Unit). One ECU alone, or a plurality of ECUs working together, sequentially execute computer programs stored in the storage that describe instruction sets for executing at least one process, while communicating with a primary computer, to perform desired operations.

The work vehicle 200 of this example embodiment further includes a positioning system 8 (see FIG. 4) and an operation terminal 400. The operation terminal 400 is a terminal for a user to perform operations related to the travel of the work vehicle and the operation of implements, and is also referred to as a virtual terminal (VT). The operation terminal 400 may include a touch screen type display device and/or one or more buttons. The display device may be, for example, a liquid crystal or organic light-emitting diode (OLED) display.

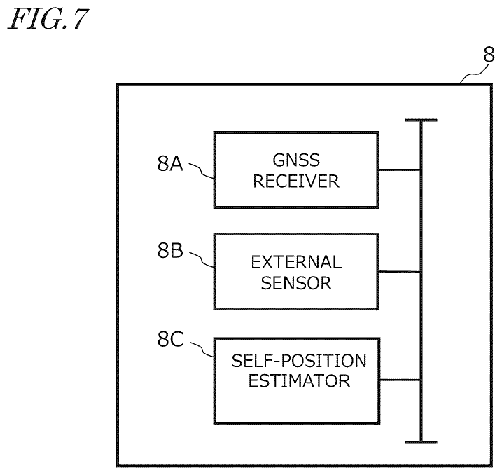

FIG. 7 is a schematic block diagram showing an example configuration of the positioning system 8. The positioning system 8 exemplified in FIG. 7 includes a GNSS receiver 8A, an external sensor 8B, and a self-position estimator 8C. The positioning system 8 may further include an RTK (Real Time Kinematic) receiver and an inertial measurement unit (IMU).

The GNSS receiver 8A includes, for example, an antenna and a GNSS receiver. The GNSS receiver 8A receives satellite signals transmitted from a plurality of GNSS satellites and generates GNSS data based on the satellite signals. The GNSS data is generated in a predetermined format, for example, the NMEA-0183 format. The GNSS data may include, for example, values indicating the identification number, elevation angle, azimuth angle, and reception strength of each satellite from which satellite signals are received.

The external sensor 8B outputs sensor data indicating the distribution of objects present in the surroundings of the work vehicle 200. Examples of external sensors include LiDAR sensors, cameras (or image sensors), laser range finders (also referred to as “scanning distance sensors”), ultrasonic sensors, millimeter-wave radars, and magnetic sensors.

The self-position estimator 8C is a device that performs estimation of the position and orientation of the work vehicle 200 (self-position estimation) using sensor data output from the external sensor 8B. For self-position estimation, algorithms such as SLAM may be used. The self-position estimator 8C may be implemented by an ECU. In this example embodiment, the self-position estimator 8C estimates the position of the work vehicle 200 by matching sensor data output from the external sensor 8B with an environmental map. The matching may be performed using any matching algorithm such as NDT (Normal Distribution Transform) or ICP (Iterative Closest Point).

In this example embodiment, the fuel tank 50 is supported by a mounting frame 120. The mounting frame 120 is fixed to the vehicle frame 102 across the driver seat 107. The fuel tank 50 is positioned above the driver seat 107. However, the installation location of the fuel tank 50 is not limited to the illustrated example and may be, for example, inside the front housing 110.

In this example embodiment, the mounting frame 120 is an elongated structure such as a pipe fixed to the vehicle frame 102. The mounting frame 120 includes two frames positioned on the left and right sides of the work vehicle 200 (see FIG. 5). The front portion of the mounting frame 120 has a curved shape. However, the shape of the mounting frame 120 shown is just an example, and the shape of the mounting frame 120 is not limited to this example.

In this example embodiment, the vehicle frame 102 includes a front frame 102A that rotatably supports the front wheels 104F and a transmission case 102B that rotatably supports the rear wheels 104R. One end (front end) of the mounting frame 120 is fixed to the front frame 102A. The other end (rear end) of the mounting frame 120 is fixed to the transmission case 102B. These fixations may be done by appropriate methods such as welding or bolt joining, depending on the material of the mounting frame 120. The mounting frame 120 may be formed from metal, synthetic resin, carbon fiber, or composite materials such as carbon fiber reinforced plastic or glass fiber reinforced plastic. The transmission case 102B includes a rear axle case, and the rear end of the mounting frame 120 may be fixed to the rear axle case. When the mounting frame 120 is formed from metal, a portion or entirety of its surface may be covered with synthetic resin.

As shown in FIG. 6, the work vehicle 200 includes a cabin 105 surrounding the driver seat 107 between the vehicle frame 102 and the mounting frame 120. The driver seat 107 is located in the rear portion of the interior of the cabin 105. In front of the driver seat 107, for example, a steering wheel 106 to change the direction of the front wheels 104F and an operation terminal 400 are provided. The cabin 105 includes a cabin frame that defines its skeleton. A roof 109 is provided on the upper portion of the cabin frame. The cabin frame in this example embodiment is a 4-pillar style. The cabin 105 is supported by the transmission case 102B of the vehicle frame 102, for example, via vibration-isolating mounts. The user interface 1 described with reference to FIG. 4 is provided inside the cabin 105. Since the cabin 105 does not directly support the fuel tank 50, there is no need to specially increase its strength, and a cabin that has been used in conventional tractors may be adopted.

The work vehicle 200 includes a placement platform 51A that connects the left frame 120 and the right frame 120. The fuel tank 50 can be positioned on the placement platform 51A. When there are a plurality of fuel tanks 50, the plurality of fuel tanks 50 may be provided in a fuel tank module 55. As shown in FIG. 6, the fuel tank module 55 includes a tank case 51 that houses a plurality of fuel tanks 50. The left and right mounting frames 120 may be connected to each other by structures other than the placement platform 51A.

A coupling device 108 is provided at the rear end of the transmission case 102B, which defines the rear portion of the vehicle frame 102. The coupling device 108 includes, for example, a three-point support device (referred to as a “three-point link” or “three-point hitch”), a PTO shaft, a universal joint, and a communication cable. The implement 300 can be attached to or detached from the work vehicle 200 using the coupling device 108. The coupling device 108 can, for example, raise and lower the three-point link by a hydraulic device to change the position or posture of the implement 300. Additionally, power can be transmitted from the work vehicle 200 to the implement 300 via the universal joint. The work vehicle 200 can execute predetermined work (agricultural task) with the implement 300 while pulling the implement 300. The coupling device 108 may be provided on the front portion of the vehicle frame 102, in which case the implement 300 can be connected to the front of the work vehicle 200.

The implement 300 may include, for example, a drive device, a controller, and a communication device. The drive device performs operations necessary for the implement 300 to execute predetermined work. The drive device includes devices appropriate for the application of the implement 300, such as hydraulic devices, electric motors, or pumps. The controller controls the operation of the drive device. The controller causes the drive device to perform various operations in response to signals transmitted from the work vehicle 200 via the communication device. The communication device can also transmit signals corresponding to the state of the implement 300 to the work vehicle 200.

The implement 300 shown in FIG. 6 is a rotary tiller, but the implement 300 is not limited to a rotary tiller. For example, any implement such as a seeder, a spreader (fertilizer applicator), a transplanter, a mower, a rake, a baler, a harvester, a sprayer, or a harrow can be connected to and used with the work vehicle 200.

The work vehicle 200 shown in FIG. 6 is capable of both manned operation and unmanned operation, but it may also be configured for unmanned operation only. In that case, components necessary only for manned operation, such as the cabin 105, steering wheel 106, and driver seat 107, may not be provided on the work vehicle 200.

The work vehicle may be equipped with an automatic driving function. That is, the work vehicle can travel by the action of the controller without manual operation. The work vehicle 200 of this example embodiment can operate in both manual driving mode and self-driving mode. In the self-driving mode, the work vehicle 200 is configured to travel unmanned. The work vehicle 200 which is unmanned is configured to travel autonomously or by remote control by a user.

The work vehicle 200 is capable of self-driving both inside and outside the field (e.g., on roads). When the work vehicle 200 performs self-driving, the controller may perform calculations and control to achieve in cooperation with the positioning system 8. In other words, the controller may perform self-driving control of the work vehicle 200 based on the estimated position of the work vehicle 200.

An example of self-driving control of the work vehicle is described in detail in the unpublished patent application filed by the present applicant, Japanese Patent Application No. 2022-097611. The entire disclosure of Japanese Patent Application No. 2022-097611 is incorporated herein by reference.

In this example embodiment, the controller changes the manner of stopping the motor 70 when a travel stop command is issued during driving of the motor 70, depending on whether the position of the work vehicle 200 identified by the positioning system 8 is within the field or not. Specifically, the controller makes the time from when the travel stop command is issued until the motor 70 stops shorter when the position of the work vehicle 200 is within the field than when the position of the work vehicle 200 is outside the field.

The time from when the travel stop command is issued until the motor 70 stops when the position of the work vehicle 200 is outside the field is referred to as the “first stop time”. The time from when the travel stop command is issued until the motor 70 stops when the position of the work vehicle 200 is within the field is referred to as the “second stop time”. The second stop time is shorter than the first stop time.

In this example embodiment, the travel stop command may be issued, for example, from the FC system ECU 5, or a primary computer that communicates with the FC system ECU 5, to the main ECU 3 or the ECU 72A that controls the driving of the motor 70. Alternatively, the travel stop command may be issued from the main ECU 3 to the ECU 72A.

The FC meter 6 is configured to display indicators that indicate the operating state of the FC power generation system 180. The display on the FC meter 6 may include, for example, an indicator to notify abnormalities in the FC power generation system 180, and indicators such as a water temperature gauge to indicate the state of the radiator device (e.g., temperature measured by the temperature sensor S3).

A pressure sensor may be provided in the fuel tank 50 to measure the remaining amount of fuel in the fuel tank 50. Furthermore, a temperature sensor may be provided to measure the temperature inside the fuel tank 50. For example, the FC system ECU 5 acquires sensor data output from the temperature sensor of the fuel tank 50 and measures the temperature of the fuel tank 50 based on the sensor data. Furthermore, the FC system ECU 5 acquires sensor data output from the pressure sensor of the fuel tank 50 and measures the pressure (residual pressure) of the fuel in the fuel tank 50 based on the sensor data.

The FC system ECU 5 determines whether each of the temperature of the fuel tank 50 and the pressure of the fuel is within a normal range. When either the temperature of the fuel tank 50 or the pressure of the fuel is not within the normal range, the FC system ECU 5 may, for example, turn on or flash an indicator notifying an abnormality in the FC power generation system 180. For example, a stop button for emergency stopping of the work vehicle 200 during automatic travel may be displayed on the screen of the operation terminal 400. When a driver seated in the driver seat 107 who notices the lighting or flashing of the indicator presses this stop button or a switch provided in the cabin 105, the main ECU 3, for example, issues a travel stop command to the ECU 72A in response to this press. The ECU 72A stops the motor 70 in response to the travel stop command.

In another example, when a user performing remote operation using a terminal device presses a stop button displayed on the terminal device, the main ECU 3, for example, may issue a travel stop command to the ECU 72A in response to this press. Alternatively, when the FC system ECU 5 detects an abnormality in the FC power generation system 180, it may issue a travel stop command to, for example, the ECU 72A. The ECU 72A stops the motor 70 in response to the travel stop command. In this manner, in this example embodiment, during the driving of the motor 70, a travel stop command is issued mainly for emergency stopping when an abnormality in the FC power generation system 180 is detected. However, the issuance of the travel stop command is not limited to when an abnormality occurs in the FC power generation system. A travel stop command may be issued when the stop button is pressed. Alternatively, for example, a travel stop command may be issued to stop the work vehicle in place when an obstacle is detected by the positioning system during self-traveling in the field.

As shown in FIG. 3, the work vehicle 200 of this example embodiment includes a first switch R1 provided in the current path between the FC module 10 and the motor 70. The work vehicle 200 may further include a second switch R2 provided in the current path between the battery 80 and the motor 70. Examples of the first switch R1 and the second switch R2 are relays. The on/off control of each of the first switch R1 and the second switch R2 is performed by, for example, the FC system ECU 5. By turning off the first switch R1, power supply from the FC module 10 to the motor 70 is shut off. By turning off the second switch R2, power supply from the battery 80 to the motor 70 is shut off.

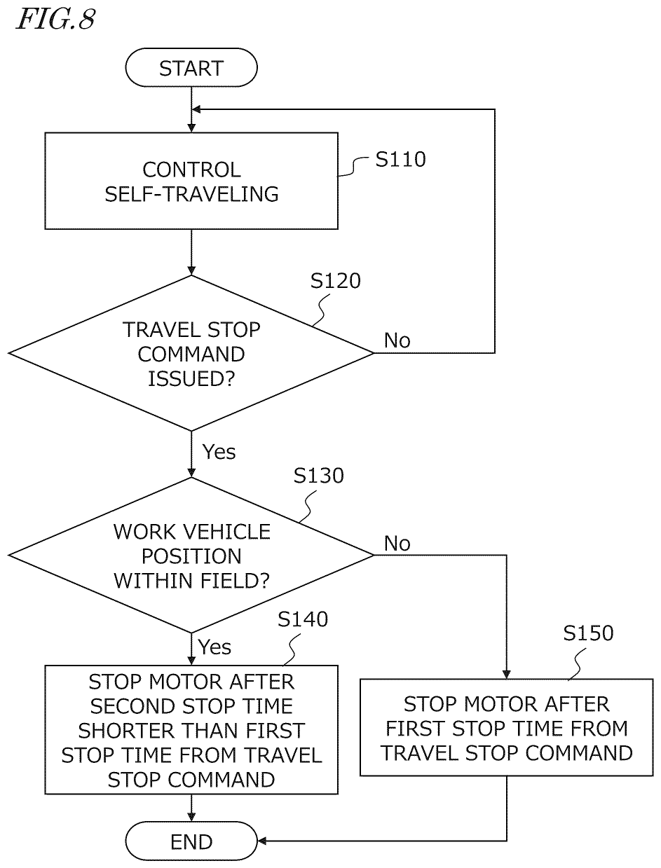

FIG. 8 is a flowchart showing an example of the processing procedure of the operation of the controller.

The controller is configured or programmed to execute automatic travel control based on sensor data output from the positioning system 8, in cooperation with the positioning system 8 (step S110).

Suppose that a driver or user notices, for example, an abnormality in the FC power generation system 180 and presses a stop button displayed on the screen of the operation terminal 400 or terminal device. In that case, a travel stop command is issued in response to this press (step S120), and the processing performed by the controller proceeds to the next step S130. The controller continues the automatic travel control until the travel stop command is issued (No in step S120, step S110).

In response to the travel stop command issued during the driving of the motor 70, the controller determines whether the position of the work vehicle 200 identified by the positioning system 8 is within the field or outside the field (step S130). The storage 7 described above may further store an environmental map of an area including one or more fields. In this example embodiment, for example, in an environment where the reception status of satellite signals transmitted from GNSS satellites is good or relatively good, the GNSS receiver 8A of the positioning system 8 performs positioning, and in an environment where the reception status is not good, the self-position estimator 8C performs self-position estimation to identify or estimate the position of the work vehicle 200.

The controller determines whether the position of the work vehicle 200 is within the field or outside the field based on the position identified by the positioning system 8 and the environmental map stored in the storage 7. For example, the controller acquires position data indicating the position of the work vehicle 200 generated by the GNSS receiver 8A. The position data includes information on the geographical coordinates of the position of the work vehicle 200. The information on geographical coordinates includes, for example, information on latitude and longitude.

The environmental map stored in the storage 7 includes information on the geographical coordinates of the area shown by the map. For example, the environmental map may include a plurality of area polygons corresponding to a plurality of areas, and further include attribute data indicating the attributes of objects located within each area. Each of the plurality of area polygons is defined by geographical coordinates.

The controller determines the area corresponding to the geographical coordinates indicated by the position data of the identified work vehicle 200 using the environmental map. The determined area corresponds to the area where the work vehicle 200 is located. In this manner, the controller is configured or programmed to determine whether the area corresponding to the geographical coordinates indicated by the position data is within the field or outside the field.

When the position of the work vehicle 200 is within the field (Yes in step S130), the controller stops the motor 70 after the second stop time from the travel stop command. For example, the controller stops the motor 70 by turning off the first switch R1 (step S140). When the position of the work vehicle 200 is within the field, the controller may stop the motor 70 by turning off both the first switch R1 and the second switch R2 in response to the travel stop command. On the other hand, when the position of the work vehicle 200 is outside the field (No in step S130), the controller stops the motor 70 after the first stop time from the travel stop command (step S150). In other words, after receiving the travel stop command, the controller maintains the driving of the motor for a certain time (e.g., the first stop time) before stopping the motor 70. After receiving the travel stop command, power supply to the motor 70 may be maintained for a predetermined time.

When the position of the work vehicle 200 is outside the field, the controller may perform the following operations instead of turning off each switch. For example, the ECU 72A stops the control of the inverter device 72 after the first stop time elapses after receiving the travel stop command. Alternatively, after receiving the travel stop command, the FC system ECU 5 may instruct the controller 42 of the FC module 10 to stop power generation after the first stop time elapses, thus stopping the power generation of the FC module 10.

In this manner, when a travel stop command is issued while performing automatic travel control, the controller stops the motor 70 at different timings depending on whether the position of the work vehicle 200 is within the field or not.

According to the stopping control of the work vehicle in this example embodiment, for a work vehicle traveling or working in the field, the controller immediately shuts off power supply to the motor by turning off the first switch in response to, for example, an emergency stop command, thereby stopping the motor. Therefore, the work vehicle traveling or working in the field can be immediately stopped in emergency. Furthermore, by turning off both the first switch and the second switch in response to, for example, an emergency stop command, the controller completely shuts off power supply to the motor immediately, enabling appropriate stopping of the motor.

For a work vehicle traveling outside the field, the controller maintains the driving of the motor for the first stop time after receiving the travel stop command, allowing the work vehicle to continue traveling. In other words, the controller does not immediately shut off power supply to the motor in response to the travel stop command. This allows, for example, for moving the work vehicle to the shoulder of the road. After moving the work vehicle to the shoulder of the road, the controller may stop the motor by turning off the first switch and/or the second switch. In this manner, the work vehicle can be safely parked in a safe place.

The work vehicle in this example embodiment is not limited to self-driving. In other words, even when the work vehicle is being manually driven, the controller can stop the motor at different timings depending on whether the position of the work vehicle is within the field or not when a travel stop command is issued during the driving of the motor, that is, during the travel of the work vehicle.

The configurations and operations of the above example embodiments are exemplary, and the present disclosure is not limited to the above example embodiments. For example, various example embodiments may be appropriately combined to configure other example embodiments.

The technologies and example embodiments of this disclosure can be applied to agricultural machines such as tractors, harvesters, rice planters, riding management vehicles, vegetable transplanting machines, mowers, seeders, fertilizer applicators, or agricultural robots.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work vehicle comprising:
a fuel cell module including a fuel cell stack;
a motor connected to the fuel cell module;
a travel device to be driven by the motor;
a controller configured or programmed to control the motor; and
a positioning system; wherein
the controller is configured or programmed to:
change a manner of stopping the motor when a travel stop command is issued during driving of the motor, depending on whether a position of the work vehicle identified by the positioning system is within a field or not; and
make a time from when the travel stop command is issued until the motor stops shorter when the position of the work vehicle is within the field than when the position of the work vehicle is outside the field.

2. The work vehicle according to claim 1, further comprising a first switch provided on a current path between the fuel cell module and the motor; wherein
the controller is configured or programmed to, in response to the travel stop command issued during driving of the motor:
determine whether the position of the work vehicle identified by the positioning system is within the field or outside the field;
when the position of the work vehicle is within the field, stop the motor by turning off the first switch; and
when the position of the work vehicle is outside the field, maintain driving of the motor for a certain time after receiving the travel stop command, and then stop the motor.

3. The work vehicle according to claim 2, further comprising:
a battery connected to the fuel cell module and the motor, and a second switch provided on a current path between the battery and the motor; wherein
when the position of the work vehicle is within the field, the controller is configured or programmed to stop the motor by turning off the first switch and the second switch in response to the travel stop command.

4. The work vehicle according to claim 1, wherein the positioning system includes a GNSS receiver.

5. The work vehicle according to claim 1, further comprising a storage to store an environmental map of an area including one or more fields; wherein
the controller is configured or programmed to determine whether the position of the work vehicle is within the field or outside the field based on the position identified by the positioning system and the environmental map.

6. The work vehicle according to claim 5, wherein the positioning system includes:
an external sensor to output sensor data indicating a distribution of objects existing around the work vehicle; and
a self-position estimator to estimate the position of the work vehicle by matching the sensor data with the environmental map.

7. The work vehicle according to claim 1, wherein the controller is configured or programmed to perform automatic travel control of the work vehicle based on an estimated position of the work vehicle.

8. The work vehicle according to claim 7, wherein when the travel stop command is issued during the automatic travel control, the controller is configured or programmed to stop the motor at different timings depending on whether the position of the work vehicle is within the field or not.

9. The work vehicle according to claim 1, wherein the work vehicle is an agricultural machine.
